(19) United States
(12) Patent Application Publication
(10) Pub. No.: US 2020/0290819 A1
(43) Pub. Date: Sep. 17, 2020

(54) METHOD FOR UNLOADING AN ITEM FOR TRANSPORT FROM A TRANSPORT BAG

(71) Applicant: FERAG AG, CH-8340 HINWIL (CH)

(72) Inventor: Martin RUGE, Starrkirch-Will (CH)

(21) Appl. No.: 16/817,252

(22) Filed: Mar. 12, 2020

(30) Foreign Application Priority Data
Mar. 15, 2019 (CH) 00328/19

(51) Int. Cl. B65G 47/38; B65G 47/61; B65G 47/96

(52) U.S. Cl. CPC B65G 47/38; B65G 47/962; B65G 47/61

(57) ABSTRACT

A method for unloading an item for transport (T) from a laterally open transport bag (2) which, hanging on a carriage (3), conveys the item for transport (T) along a running rail (4) in a conveying direction, the item for transport (T) lying on a support surface (21) of the transport bag (2) and the item for transport (T) being unloaded laterally by virtue of a part (211) of the support surface (21) of the transport bag (2) being raised in the direction of the hanging point (P) of the transport bag (2) on the carriage (3) by means of a raising device (11).

### CROSS-REFERENCE TO RELATED APPLICATIONS

Swiss Patent Applications 00328/19, filed 15 Mar. 2019, the priority document corresponding to this invention, to which a foreign priority benefit is claimed under Title 35, United States Code, Section 119, and their entire teachings are incorporated, by reference, into this specification.

### BACKGROUND OF THE INVENTION

### Field of the Invention

The present invention relates to the field of conveying technology and concerns a method for unloading an item for transport from a laterally open transport bag and a bag unloading device for carrying out such a method.

### Discussion of Related Art

During the conveying of items for transport by means of suitable transport bags, the unloading of the items for transport from the transport bags is an aspect in the case of which a simple and fast method with the highest possible level of automation is desired.

The prior art has disclosed multiple approaches for the unloading of items for transport from transport bags. EP2686258, for example, describes a hanging conveyor system with a transport bag for the automatic unloading of a loaded item of piece goods and with an unloading station, wherein the transport bag has a main body and a separate receptacle which closes against said main body. The unloading of the transport bag takes place through one of the face sides, which is of open form, of the main body, wherein an oppositely situated face side is likewise of open form. The bottom side of the main body couples to the top side of the receptacle, in order to define a receptacle space below the main body, wherein the lateral sides of the receptacle are formed such that the base can be raised into an unloading position of the transport bag, in which the base has been raised into the bottom side of the main body. The transport bag has in each case one retention device which, in the region of the face sides, extends at least along a transition between the main body and the receptacle. The unloading station has a raising device and a pushing device, wherein the raising device is configured to, when the transport bag is situated in an unloading position, raise the base of the receptacle of the transport bag laden with at least one item of piece goods vertically such that the at least one item of piece goods can, by means of the pushing device, be pushed out horizontally through one of the face sides of the main body of the transport bag.

### SUMMARY OF THE INVENTION

It is an object of the invention to provide a method for unloading an item for transport from a laterally open transport bag and a bag unloading device for carrying out such a method, which at least partially improve the prior art relating to the unloading of items for transport from laterally open transport bags.

Said object is achieved by means of the features of the independent claims. Advantageous refinements of the invention are specified in the dependent claims and in the present description and the figures.

The invention relates to a method for unloading an item for transport from a laterally open transport bag which, hanging on a carriage, conveys the item for transport along a running rail in a conveying direction, the item for transport lying on a support surface of the transport bag and the item for transport being unloaded laterally by virtue of a part of the support surface of the transport bag being raised in the direction of the hanging point of the transport bag on the carriage by means of a raising device.

In particular, a part of the support surface of the transport bag is raised such that a remaining part of the support surface is lowered relative to the raised part. By means of the raising of a part of the support surface of the laterally open transport bag, the item for transport can be unloaded from the transport bag in automated fashion without the need for complicated ejection devices such as for example pushing means. The unloading process can advantageously be performed substantially by means of a single linear movement of the raising action, such that a coordination of different movement sequences, such as for example a raising action and an ejection action, which is cumbersome from a control aspect, can be avoided. By means of the linear raising of only a part of the support surface of the transport bag, it is furthermore not necessary, during the unloading process, for the entire transport bag to be moved, it rather advantageously sufficing to move substantially only the support surface or the raised part of the support surface. The efficiency and precision of the unloading process can thus be increased.

In conjunction with the present invention, it is clear to a person skilled in the art that “laterally open” transport bags refers to transport bags which have a lateral opening such that a lateral removal of the item for transport is possible, wherein this expression may also encompass transport bags with lateral securing elements or wall elements. The “height” of parts of the transport bag is generally to be understood in relation to the hanging point of the transport bag on the carriage.

The transport bags are advantageously conveyed in a hanging conveyor device by means of carriages which are movable on a running rail.

In one embodiment, a lateral part of the support surface of the transport bag is raised such that the support surface of the transport bag forms a slope transverse to the conveying direction.

As a result of the formation of a slope, the item for transport can slide laterally out of the transport bag under the action of gravitational force, without the need for additional removal processes such as for example ejection or picking-out of the item for transport.

In one embodiment, an upper edge region, facing toward the carriage, of the transport bag remains at a constant height during the raising of the part of the support surface of the transport bag.

In particular, the part of the support surface of the transport bag may be raised such that an upper edge of the transport bag is not moved, that is to say the position of the edge in relation to the hanging point of the transport bag on the carriage remains unchanged. In certain refinements, the transport bag comprises, in the upper edge region, a movably mounted frame. In these refinements, the part of the support surface of the transport bag may be raised such that the position of the frame remains unchanged during the raising of the part of the support surface.

In one refinement, a wall surface, adjoining the support surface, of the transport bag is deformed during the raising of the part of the support surface.

Preferably, the transport bag comprises a flexible material web which forms a transport strap such that the wall surfaces, adjoining the support surface, of the transport bags are at least partially deformable. As a result of the raising of a part of the support surface, in particular while maintaining the height of the upper edge region of the transport bag, it is thus possible for a wall surface adjoining the support surface, generally the front and/or rear wall in relation to the conveying direction, to be deformed.

In particular, the part of the support surface of the transport bag may be raised such that a first and an oppositely situated second lateral opening of the transport bag move relative to one another.

In one refinement, the support surface of the transport bag is, during the raising of the part of the support surface, pivoted about a preferably horizontal axis running through the support surface of the transport bag.

Preferably, the axis runs perpendicular to a lateral unloading direction of the transport bag. In one refinement, the axis runs substantially parallel to the conveying direction of the transport bag or of the carriage.

Alternatively, the support surface of the transport bag may, during the raising of the part of the support surface, be pivoted about a preferably horizontal axis running through the interior space of the transport bag.

In particular, it is advantageously the case that, during the raising process, only the support surface and not the entire transport bag is pivoted, which simplifies the unloading process.

In one refinement, the support surface of the transport bag is subjected to a linear displacement superposed on the pivoting movement.

The linear displacement may take place in a vertical direction or in some other direction. It is clear to a person skilled in the art that an offsetting of the support surface may be performed in a manner superposed on the raising of the part of the support surface or on the pivoting movement. Even in the case of a superposed linear displacement of the support surface itself, however, a part of the support surface is raised relative to a remaining part of the support surface, such that the support surface can form a slope.

In one refinement, the spacing between a first and a second wall surface, adjoining the support surface, of the transport bag is increased during the raising of the part of the support surface.

In one refinement, the carriage is stopped for the purposes of unloading the item for transport from the transport bag. In particular, the carriage may be stopped, and the part of the support surface of the transport bag may be raised subsequently. This may be particularly advantageous if, for the raising of the part of the support surface of the transport bag, use is made of an active raising device such as for example a height-adjustable plunger or an engagement means such as for example a hook, a loop etc.

In further refinements, the item for transport is unloaded from the transport bag during the conveying movement of the carriage. In particular, the part of the support surface of the transport bag may be raised during the conveying movement of the carriage. This may be particularly advantageous if, for the raising of the part of the support surface of the transport bag, use is made of a passive raising device such as for example a motion guide and an engagement means such as for example a roller, a pin etc.

The invention furthermore relates to a bag unloading device for carrying out the method according to the present invention, comprising a raising device which is designed to raise a part of a support surface of a transport bag in the direction of the hanging point of the transport bag on the carriage such that the support surface forms a slope transverse to the conveying direction.

By means of the slope, an unloading direction transverse with respect to the conveying direction can be defined, such that the item for transport can be unloaded laterally from the transport bag by sliding down the slope. The raising device is preferably configured to interact with a subregion around that part of the support surface of the transport bag which is to be raised, wherein the raising may be performed by means of a pulling movement of the raising device from above the support surface and/or by means of a pushing movement of the raising device from below the support surface.

In one refinement, the raising device is configured to raise the part of the support surface with an impulse sufficient to overcome the static friction of the item for transport lying on the support surface.

Preferably, the raising device is designed to interact only with the subregion around that part of the support surface of the transport bag which is to be raised in such a way that an upper edge region, facing toward the carriage, of the transport bag remains at a constant height during the raising of the part of the support surface.

Since it is generally sufficient for the raising device to be configured to effect a linear raising movement of the part of the support surface, the bag unloading device can be of simpler design in relation to solutions from the prior art. For example, it is possible to avoid complicated bearing arrangements at the hanging point of the transport bag on the carriage, which would be required for example for a pivoting of the transport bag as a whole.

In one refinement, the bag unloading device comprises a sensor which is configured to determine the, in particular vertical, position of the support surface. The raising device can adapt the stroke during the raising movement to the determined position of the support surface. The sensor may alternatively or additionally be configured to determine the dimensions of the transport bag and/or of the item for transport. The raising device can adapt the stroke during the raising movement to the determined dimensions of the transport bag and/or of the item for transport. The sensor may be connected to a controller to which the determined position and/or dimensions are transmitted. The controller is advantageously designed to control the raising device, in particular adapt the stroke and/or the impulse of the raising movement, on the basis of the position and/or dimensions determined by the sensor.

In one refinement, the raising device is designed to raise the part of the support surface of the transport bag such that a wall surface, adjoining the support surface, of the transport bag is deformed.

In one refinement, the raising device comprises a height-adjustable plunger which is configured to, from below the support surface, displace the part of the support surface of the transport bag in the direction of the hanging point of the transport bag on the carriage.

The plunger is preferably arranged offset from a central vertical axis of the transport bag, such that the plunger can raise a lateral subregion of the bag.

In one refinement, the bag unloading device comprises two plungers which are arranged opposite one another in a manner offset from the central vertical axis of the transport bag. By means of this arrangement, the support surface of the transport bag can be selectively raised in both lateral directions of the transport bag, such that unloading of the item for transport in both lateral directions or out of both lateral openings of the transport bag is made possible.

In one refinement, the plunger has a pushing surface which has a gradient transverse to the conveying direction, the pushing surface being designed to slope downward in an unloading direction.

By means of the pushing surface, the plunger can assist the formation of a slope. In particular in the case of a flexible support surface of the transport bag, the pushing surface of the plunger can stabilize the slope.

In one refinement, the plunger has a pushing surface which is pivotable about a horizontal axis. By means of the pivoting of the pushing surface, the unloading direction can be changed from one side of the transport bag to the opposite side of the transport bag.

In one refinement, the raising device has a positionally fixedly arranged motion guide which is designed to, from below the support surface, raise the part of the support surface of the transport bag. The motion guide is preferably arranged offset from a central vertical axis of the transport bag, such that a lateral part of the support surface of the transport bag can travel over the motion guide and be raised by the motion guide.

Preferably, the transport bag has, in the region of the support surface, a reinforcement which assists the formation of a slope as the support surface travels over the motion guide. The reinforcement may comprise struts, strips, rods or the like.

In one refinement, the raising device comprises a first engagement means which is designed to engage into a second engagement means of the transport bag and raise the part of the support surface of the transport bag in the direction of the hanging point of the transport bag on the carriage.

The first and/or the second engagement means may comprise inter alia at least one out of hook, comb, loop, edge, motion guide, roller, pin.

For example, the first engagement means may comprise a hook and the second engagement means may comprise a loop arranged laterally on the transport bag, such that the hook can engage into the loop and raise a lateral part of the support surface of the transport bag by means of a pulling movement, wherein the raising device is in this case arranged above the support surface of the transport bag.

In one refinement, the second engagement means comprises multiple loops which are arranged laterally on the transport bag and into which a hook or a comb of the first engagement means can engage. This has the advantage that the reliability of the engagement of the first and of the second engagement means into one another can be increased.

Alternatively and correspondingly, the first engagement means may comprise a loop, and the second engagement means may comprise a hook.

A hook of the first engagement means may also engage into an edge of the second engagement means of the transport bag. Alternatively and correspondingly, an edge of the first engagement means may engage into a hook of the second engagement means of the transport bag. It is also conceivable for the first engagement means and the second engagement means to each comprise edges which are designed such that they can engage into one another.

In a further example, the first engagement means may comprise a fixedly arranged motion guide over which a roller arranged laterally on the transport bag or a pin of the transport bag arranged laterally on the transport bag can be guided such that a lateral part of the support surface of the transport bag is raised. In this case, the item for transport can advantageously be unloaded without stopping the transport bag.

In a further refinement, the raising device comprises a roller which is designed to, by rotation, raise a part of the support surface such that the support surface forms a slope transverse to the conveying direction.

Preferably, the roller has an axis of rotation which is oriented horizontally and perpendicularly to a lateral unloading direction. The roller is preferably arranged offset from a central vertical axis of the transport bag.

In one refinement, the roller is designed as a brush roller, the brush roller having a brush trim which is configured to raise a part of the support surface of the transport bag in the direction of the hanging point of the transport bag on the carriage.

In one refinement, the roller is designed as a brush roller, the brush roller having a brush trim which, in a resting configuration, lies against the brush roller and, during rotation, is set radially upright and thus increases the effective diameter of the brush roller. Owing to the radial setting-upright of the brush trim, the brush roller can, by rotation, effect a linear raising of a part of the support surface of the transport bag. The brush trim may extend over the entire circumference or over a part of the circumference of the brush roller.

In a further refinement, the roller is designed as a brush roller with a brush trim, wherein the brush trim extends over a part of the circumference of the brush roller and has a trim length which varies over the part of the circumference, preferably increases counter to a direction of rotation.

In one refinement, the roller has a projection which is configured to, in the case of rotation of the roller, raise a part of the support surface of the transport bag.

The projection of the roller may be designed as a cam. The cam may comprise bearing rollers which make it easier for the cam to roll on the support surface that is to be pushed against. The cam may be designed as a curved limb.

The invention furthermore relates to a conveying device comprising a bag unloading device according to the present invention, a running rail and a multiplicity of laterally open transport bags which, in each case hanging on a carriage which is movable along the running rail, can be conveyed in a conveying direction.

In one refinement, the conveying device comprises a controller which is configured to control the raising device of the bag unloading device such that the raising device raises a part of a support surface of a transport bag for the purposes of unloading an item for transport from the transport bag. The controller may, as described above, be connected to a sensor of the bag unloading device, which sensor is configured to determine, and transmit to the controller, the position of the support surface of a transport bag and/or the dimensions of a transport bag and/or of an item for transport in the transport bag.

Preferably, the carriages can be conveyed with variable spacing to one another on the running rail. In certain refinements, the carriages can be conveyed on the running rail by means of a conveying chain.

In one refinement, the support surface of the transport bag is inclined in the conveying direction or counter to the conveying direction. The spacing of the front and rear walls, in relation to the conveying direction, of the transport bag to one another may be increased prior to the raising of the part of the support surface. The support surface may in this case be pivoted about an axis oriented transversely with respect to the conveying direction, such that the inclination of the support surface is varied.

In one refinement, the transport bag has lateral wall elements which, during transport, prevent the item for transport from sliding out laterally.

As a result of the pivoting of the support surface about the axis oriented transversely with respect to the conveying direction, the item for transport can be displaced relative to the lateral wall elements, such that unloading by sliding out laterally is made possible.

The transport bags may have, in the upper edge region, a pivot frame which is pivotable such that the spacing between the front and rear walls of the transport bag is variable.

The pivot frame may be pivoted counted to the conveying direction or in the conveying direction for example by means of suitable motion guides.

In one refinement, the transport bags each comprise a flexible material web which, in each case forming a transport strap, hangs on a hanging point on the carriage, the transport bag having, in the region of the support surface, a reinforcement. Preferably, the reinforcement is configured to interact with the raising device for the raising of a part of the support surface of the transport bag.

The flexible material web does not need to hang directly, but rather may hang via a suitable suspension device, on the carriage. For example, the flexible material web may hang on the carriage via a pivot frame and a suspension for the pivot frame.

The reinforcement is advantageously designed such that, during the raising of the part of the support surface, the formation of a slope is assisted or permitted. Preferably, the reinforcement is oriented transversely with respect to the conveying direction or along an unloading direction.

The reinforcement may comprise struts, strips, rods or the like. Preferably, the struts, strips, rods or the like are incorporated into the transport bag or into the flexible material web.

In certain refinements, the transport bag comprises a flexible material web without reinforcement of the transport bag in the region of the support surface. For example, this may be the case in a refinement of the raising device comprising a plunger with an inclined pushing surface, because the pushing surface of the plunger provides the slope.

In one refinement, the transport bags have, in the region of at least one wall surface, adjoining the support surface, of the transport bag, a reinforcement structure which is configured to provide predetermined fold points at which the transport bag is deformable during the raising of the part of the support surface of the transport bag.

The predetermined fold points may advantageously serve for configuring the deformability of the wall surfaces of the transport bags such that the spacing between the front and rear walls of the transport bag is increased during the raising of the part of the support surface of the transport bag. In this way, a lateral opening of the transport bag can be suitably enlarged in the unloading direction such that the unloading of the item for transport is simplified.

### BRIEF DESCRIPTION OF SEVERAL VIEWS OF THE DRAWINGS

Aspects of the invention will be discussed in more detail on the basis of the exemplary embodiments shown in the following figures and the associated description. In the figures:

FIG. 1 shows a perspective view of an embodiment of a bag unloading device in a configuration prior to raising of a part of a support surface of a transport bag;

FIG. 2 shows the bag unloading device from FIG. 1 during the raising of the part of the support surface;

FIG. 3a shows an embodiment of a transport bag with a pivot frame in a frontal view;

FIG. 3b shows a side view of two configurations of the transport bag from FIG. 3a;

FIG. 4a shows a frontal view of an embodiment of a bag unloading device with a raising device comprising a brush roller, with the brush roller in a resting configuration;

FIG. 4b shows the bag unloading device from FIG. 4a with the brush roller during a rotational movement;

FIG. 5a shows a frontal view of an embodiment of a bag unloading device comprising a motion guide in a configuration prior to the raising of a part of the support surface;

FIG. 5b shows the bag unloading device from FIG. 5a during the raising of the part of the support surface;

FIG. 5c shows the motion guide from FIG. 5a and FIG. 5b in a side view;

FIG. 6a shows a frontal view of one embodiment of a transport bag with reinforcement structures of the wall surfaces;

FIG. 6b shows a frontal view of one embodiment of a transport bag with reinforcement structures of the wall surfaces;

FIG. 6c shows a frontal view of one embodiment of a transport bag with reinforcement structures of the wall surfaces;

FIG. 7a shows a frontal view of an embodiment of a bag unloading device with a raising device comprising a roller with a cam in two different configurations;

FIG. 7b shows a frontal view of an embodiment of a bag unloading device with a raising device comprising a roller with a cam in two different configurations;

FIG. 8a shows a frontal view of an embodiment of a bag unloading device with a raising device comprising a brush roller in a first configuration;

FIG. 8b shows a frontal view of an embodiment of a bag unloading device with a raising device comprising a brush roller in a second configuration;

FIG. 9a shows a frontal view of an embodiment of a bag unloading device with a raising device comprising a roller, with a cam designed as a curved limb, in a first configuration;

FIG. 9b shows a frontal view of an embodiment of a bag unloading device with a raising device comprising a roller, with a cam designed as a curved limb, in a second configuration;

FIG. 10a shows a frontal view of an embodiment of a bag unloading device with a raising device comprising two oppositely arranged plungers;

FIG. 10b shows a frontal view of an embodiment of a bag unloading device with a raising device comprising two oppositely arranged plungers;

FIG. 10c shows a frontal view of an embodiment of a bag unloading device with a raising device comprising two oppositely arranged plungers;

FIG. 11a shows a frontal view of an embodiment of a bag unloading device with a raising device comprising one plunger with a pushing surface; and

FIG. 11b shows a frontal view of an embodiment of a bag unloading device with a raising device comprising one plunger with a pushing surface.

### DESCRIPTION OF PREFERRED EMBODIMENTS

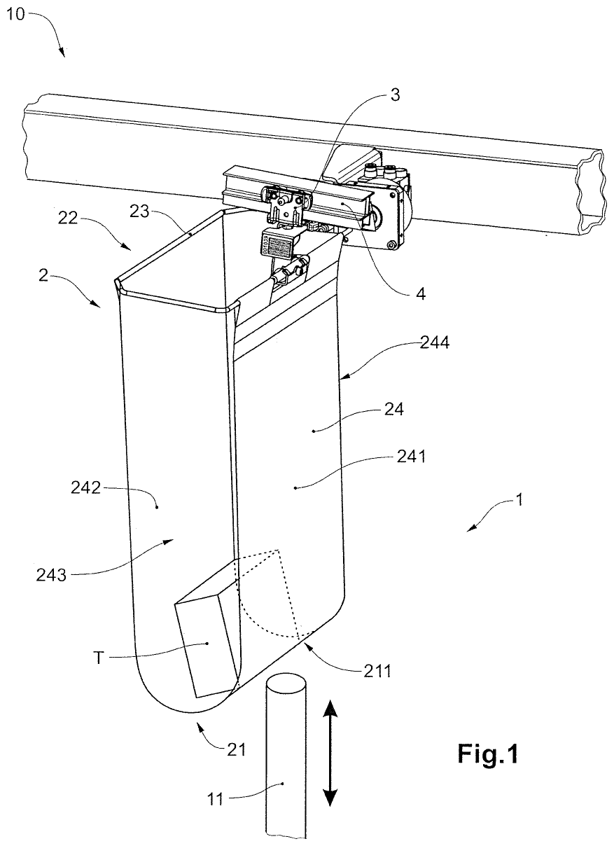

FIG. 1 shows a perspective view of an embodiment of a bag unloading device 1 in a configuration prior to the raising of a part 211 of a support surface 21 of a laterally open transport bag 2. The transport bag 2 is attached in a hanging manner to a carriage 3 which is arranged such that it can be conveyed on a running rail 4 of a conveying device 10. In the upper edge region 22, the transport bag 2 has a pivot frame 23 which can be pivoted for example by means of a motion guide.

The transport bag 2 comprises a flexible material web 24 which, forming a transport strap, is attached at its ends to the pivot frame 23. Situated in the transport bag 2 is an item for transport T, which lies on the curved support surface 21. The support surface 21 is adjoined by a front wall surface 241 and a rear wall surface 242, which form a front wall and rear wall of the transport bag 2. The material web 24 formed as a transport strap forms two lateral openings 243 and 244 of the transport bag 2, from which the item for transport T can be unloaded.

As a result of the pivoting of the pivot frame 23, the spacing between the front wall surface 241 and the rear wall surface 242 can be varied.

FIG. 1 shows the pivot frame 23 in a horizontal configuration, in which the spacing between the front wall surface 241 and the rear wall surface 242 is at a maximum and therefore an unloading of the item for transport T from the lateral openings 243 and 244 is promoted.

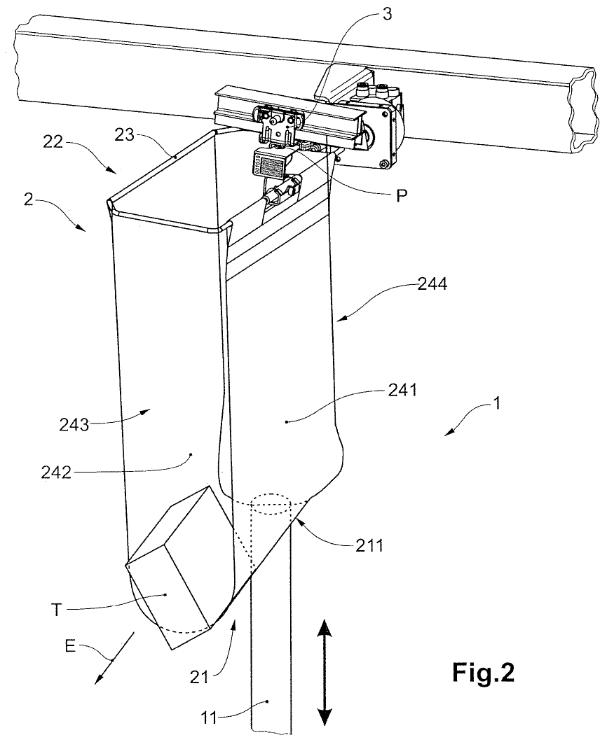

Arranged below the support surface 21 is a height-adjustable plunger 11 of a raising device. The height-adjustability of the plunger 11 is indicated by the double arrow. The plunger 11 is arranged offset from a central vertical axis of the transport bag 2, such that, when it pushes against the support surface 21, a lateral part 211 of the support surface 21 is raised, as can be seen in FIG. 2.

FIG. 2 shows the bag unloading device 1 from FIG. 1 during the raising of the lateral part 211 of the support surface 21 of the transport bag 2. The carriage 3 has been stopped for the purposes of unloading the item for transport T from the transport bag 2. In relation to the configuration in FIG. 1, the plunger 11 has been deployed upward, such that the plunger 11 raises the part 211 of the support surface 21. As a result of the raising of the part 211, the support surface 21 forms a slope in a lateral unloading direction E, such that the item for transport T slides out of the opening 243.

It can also be seen that, as a result of the raising of the part 211 by the plunger 11, both the front wall surface 241 and the rear wall surface 242 are deformed, and the opening 244 moves relative to the opening 243. During the raising of the part 211 of the support surface 21, the upper edge region 22 and the pivot frame 23 remain at a constant height. In particular, the position of the edge region 22 in relation to the hanging point P of the transport bag 2 on the carriage 3 remains unchanged.

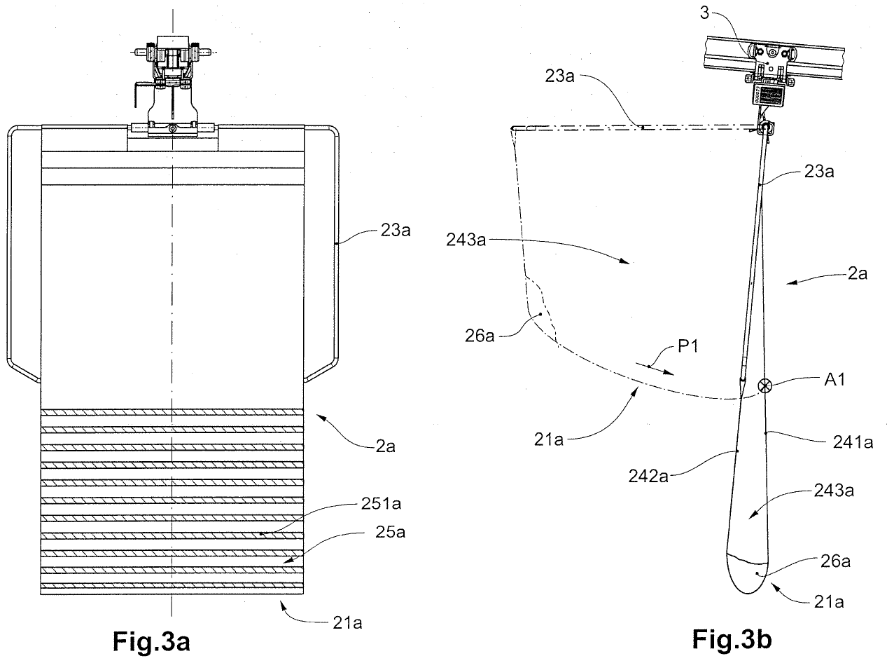

FIG. 3a shows an embodiment of a laterally open transport bag 2a with a pivot frame 23a in a frontal view. The transport bag 2a has, in the region of the support surface 21a, a reinforcement 25a which comprises struts 251a oriented transversely with respect to the conveying direction. A corresponding reinforcement of the transport bag in the region of the support surface is also conceivable for the transport bags shown in the other figures. In particular for the transport bags 2 and 2b-c, 2g-j in FIGS. 1, 2, 4, 5 and 7-10, such a reinforcement is particularly advantageous in order to assist the formation of a slope of the support surface.

FIG. 3b shows a side view of two configurations of the laterally open transport bag 2a from FIG. 3a. The configuration of the transport bag 2a shown by solid lines corresponds to the configuration shown in FIG. 3a, in which the pivot frame 23a hangs substantially vertically downward from the carriage 3 and the front wall surface 241a and the rear wall surface 242a have a small spacing to one another. The transport bag 2a has lateral wall elements 26a which prevent an item for transport conveyed in the transport bag 2a from being able to fall laterally out of the transport bag 2a. The support surface 21a of the transport bag 2a can, by pivoting of the pivot frame 23a, be pivoted about an axis A1 which is oriented transversely with respect to the conveying direction and which projects into the plane of the drawing, as shown by way of the configuration illustrated by the dash-dotted lines.

As a result of the pivoting of the support surface 21a about the axis A1, which is oriented transversely with respect to the conveying direction, the item for transport is displaced relative to the lateral wall elements 26a in the direction of the arrow P1, such that unloading out of a lateral opening 243a is made possible. It can furthermore be seen that the lateral opening 243a is increased in size as a result of pivoting of the pivot frame 23a.

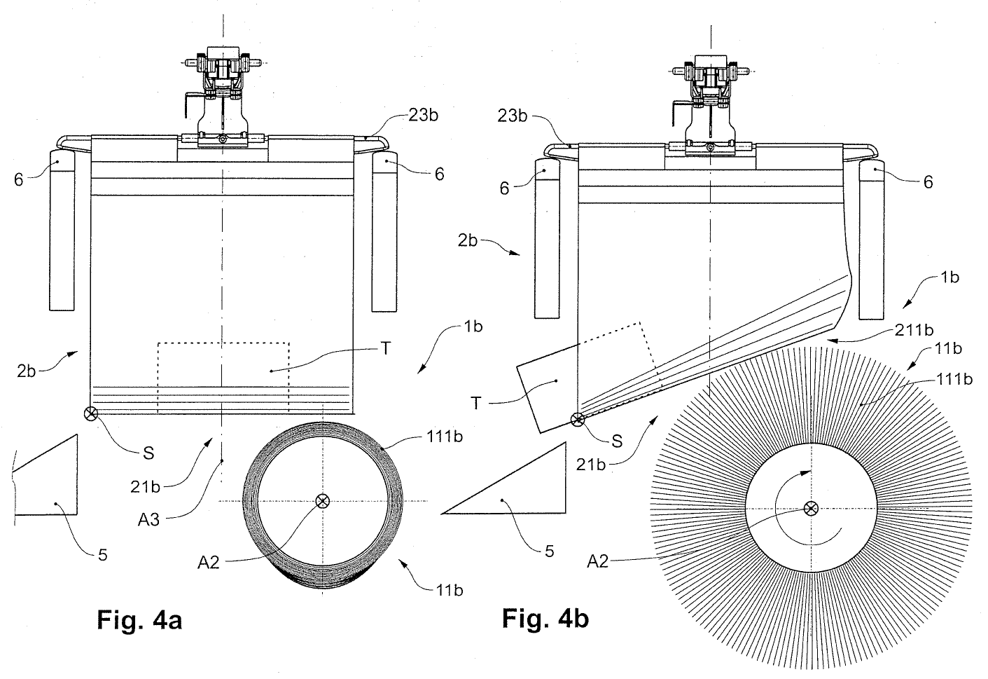

FIG. 4a shows a frontal view of an embodiment of a bag unloading device 1b having a raising device comprising a brush roller 11b, with the brush roller 11b in a resting configuration. The brush roller 11b has an axis of rotation A2 which is oriented horizontally and perpendicular to a lateral unloading direction and which is arranged offset from a central vertical axis A3 of the transport bag 2b. The brush roller has a brush trim 111b, which is lying against the brush roller 11b.

FIG. 4b shows the bag unloading device 1b from FIG. 4a with the brush roller 11b during a rotational movement about the axis of rotation A2. In relation to the resting configuration in FIG. 4a, the brush trim 111b has been set radially upright, such that the effective diameter of the brush roller 11b transversely with respect to the axis of rotation A2 has thus been increased. Owing to the radial setting-upright of the brush trim 111b, a lateral part 211b of the support surface 21b of the transport bag 2b has been linearly raised. The brush trim 111b extends over the entire circumference of the brush roller 11b.

As a result of the linear raising of the lateral part 211b, the support surface 21b forms a slope in an unloading direction, such that the item for transport T can be unloaded laterally from the transport bag 2b. It can be seen in FIG. 4b that the item for transport T is sliding from the transport bag 2b onto a ramp 5 arranged at the bag unloading device 1b.

Both in FIG. 4a and in FIG. 4b, the pivot frame 23b is situated on a motion guide 6 by means of which the pivot frame 23b is pivoted into a horizontal position and held in said position, such that the spacing between the front and rear wall surfaces of the transport bag 2b is enlarged and the item for transport T can be easily unloaded from a lateral opening of the transport bag 2b.

Stopping of the rotation of the brush roller 11b causes the brush trim 111b to lie against the brush roller 11b again, such that the part 211b of the support surface 21b can, as required, for example after the unloading of the item for transport T, be lowered again (correspondingly to FIG. 4a).

It can be seen in FIGS. 4a and 4b that, during the raising of the part 211b, the support surface 21b is pivoted about an axis S running through the support surface 21b.

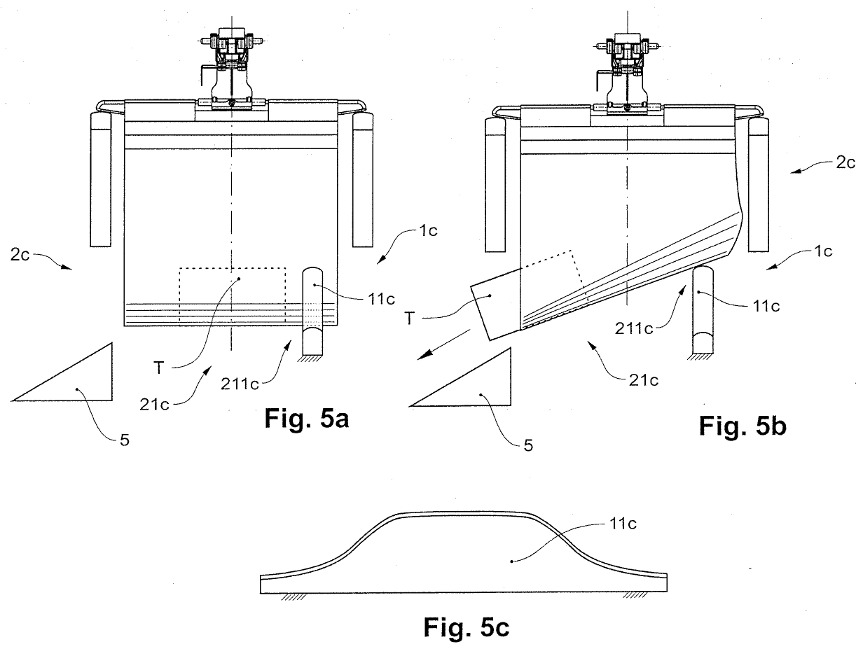

The curvature of the transport bag 2b in the lower region of the transport bag 2b corresponding to the curvature of the transport bag 1 shown in FIG. 1 is indicated by means of horizontal lines in the lower region of the transport bag 2b. Corresponding lines are shown for the transport bags in FIGS. 5a-b, 6a-c, 7a-b, 8a-b, 9a-b, 10a-c and 11a-b.

FIG. 5a shows a frontal view of an embodiment of a bag unloading device 1c comprising a raising device designed as a motion guide 11c in a configuration prior to raising of a part 211c of the support surface 21c of the transport bag 2c. The conveying direction of the transport bag 2c points out of the plane of the drawing. The motion guide 11c is arranged offset from the central vertical axis of the transport bag 2c.

FIG. 5b shows the bag unloading device 1c from FIG. 5a during the raising of the part 211c of the support surface 21c by the motion guide 11c. In relation to FIG. 5a, the transport bag 2c has moved slightly further in the conveying direction and has thus travelled onto an elevated region of the motion guide 11c, such that the motion guide 11c, from below the support surface 21c, raises the lateral part 211c of the support surface 21c in the direction of the hanging point of the transport bag 2c on the carriage. As a result of the raising of the part 211c of the support surface 21c, a slope is formed transversely with respect to the conveying direction, such that the item for transport T slides laterally out of the transport bag 2c onto a ramp 5.

FIG. 5c shows the motion guide 11c from FIG. 5a and FIG. 5b in a side view.

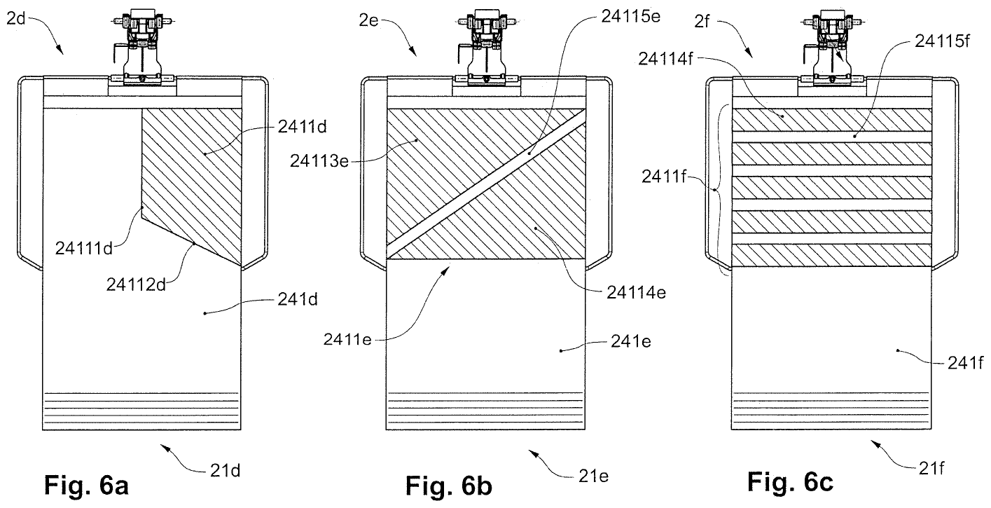

FIG. 6a shows a frontal view of an embodiment of a transport bag 2d with a reinforcement structure 2411d of the front wall surface 241d. The rear wall surface, which is not visible in FIG. 6a, may likewise have a corresponding reinforcement structure. The reinforcement structure 2411d comprises for example a hollow chamber plate composed of plastic. By means of the reinforcement structure 2411d, predetermined fold points are provided along the edges 24111d and 24112d, at which predetermined fold points the transport bag 2d is preferentially deformed during the raising of a part of the support surface 21d. As a result of the deformation of the transport bag 2d along the predetermined fold points 24111d and 24112d, a lateral opening of the transport bag 2d is increased in size in a manner which is expedient for the lateral unloading of an item for transport.

FIG. 6b shows a frontal view of a further embodiment of a transport bag 2e with a reinforcement structure 2411e of the front wall surface 241e comprising two sub-plates 24113e and 24114e, which provide a diagonally oriented predetermined fold point 24115e of the transport bag 2e. The rear wall surface of the transport bag 2e may likewise have a corresponding reinforcement structure.

FIG. 6c shows a frontal view of a further embodiment of a transport bag 2f with a reinforcement structure 2411f of the front wall surface 241f, which comprises multiple similar sub-plates 24114f. By means of the sub-plates 24114f, multiple horizontal predetermined fold points 24115f of the transport bag 2f are provided. The sub-plates 24114f may, in particular embodiments, be designed as strips, struts, rods or the like.

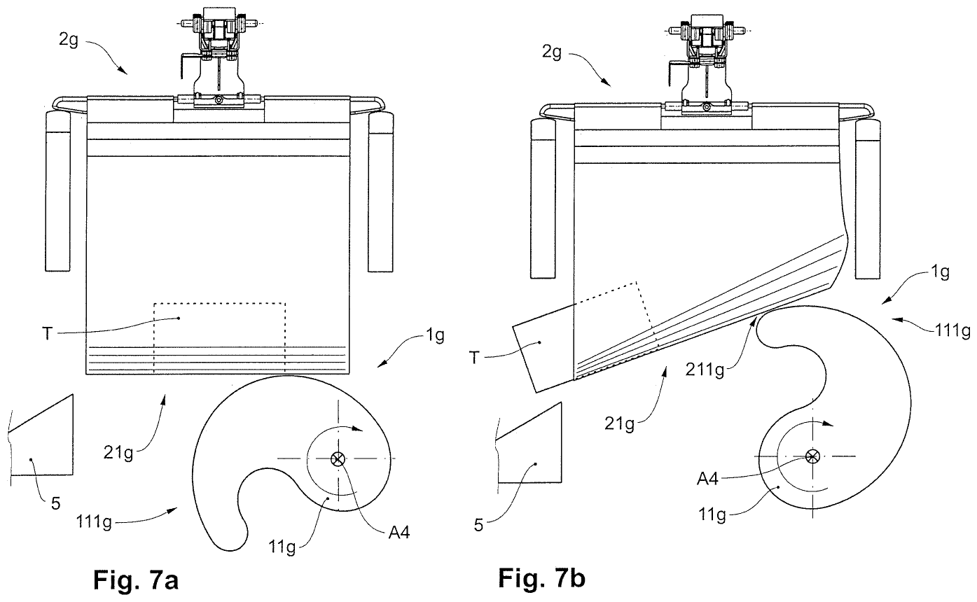

FIGS. 7a-b show frontal views of an embodiment of a bag unloading device 1g having a raising device comprising a roller 11g with a cam 111g in two different rotational configurations. The roller 11g is rotatable about a horizontal axis A4. The cam 111g is designed as a curved limb. Rotation of the roller 11g and corresponding pushing against the support surface 21g by the cam 111g cause the part 211g to be raised in the direction of the hanging point of the transport bag 2g on the carriage, such that the support surface 21g forms a slope in an unloading direction. The item for transport T slides out of the transport bag 2g along the slope onto a ramp 5.

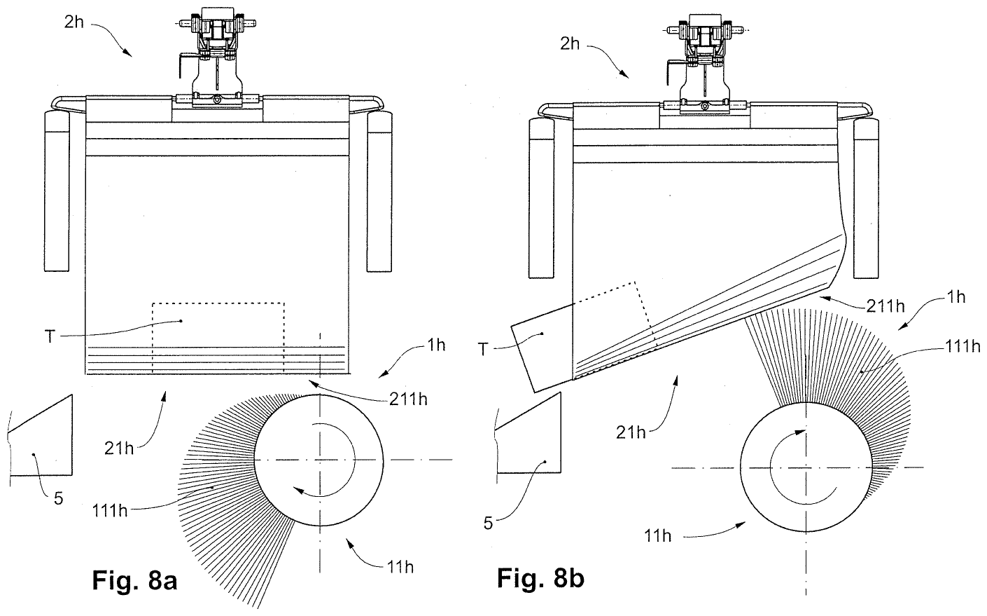

FIGS. 8a-b show frontal views of an embodiment of a bag unloading device 1h having a raising device comprising a brush roller 11h in two different rotational configurations. The brush roller 11h has a brush trim 111h which extends over a part of the circumference of the brush roller 11h.

The brush trim 111h has a radial trim length which varies over the part of the circumference of the brush roller 11h and which increases counter to the direction of rotation. The brush roller 11h is arranged laterally offset from a central vertical axis of the transport bag 2h. As a result of the varying trim length and the arrangement of the brush roller 11h, a lateral part 211h of the support surface 21h can be raised when the brush roller 11h rotates, as shown in FIG. 8b.

As a result of the raising of the part 211h, the support surface 21h of the transport bag 2h forms a slope, such that the item for transport T can slide laterally out of the transport bag 2h. If the brush roller 11h is rotated onward from the configuration in FIG. 8b, the part 211h of the support surface 21h is lowered again, because a part of the circumference of the brush roller 11h without brush trim 111h comes into position below the support surface 21h.

It is also conceivable for the radial trim length of the brush trim to decrease again counter to the direction of rotation at a particular point, such that the part 211h of the support surface 21h can be correspondingly lowered again after being raised. In such a case, it would also be possible for the brush trim to extend over the entire circumference of the roller.

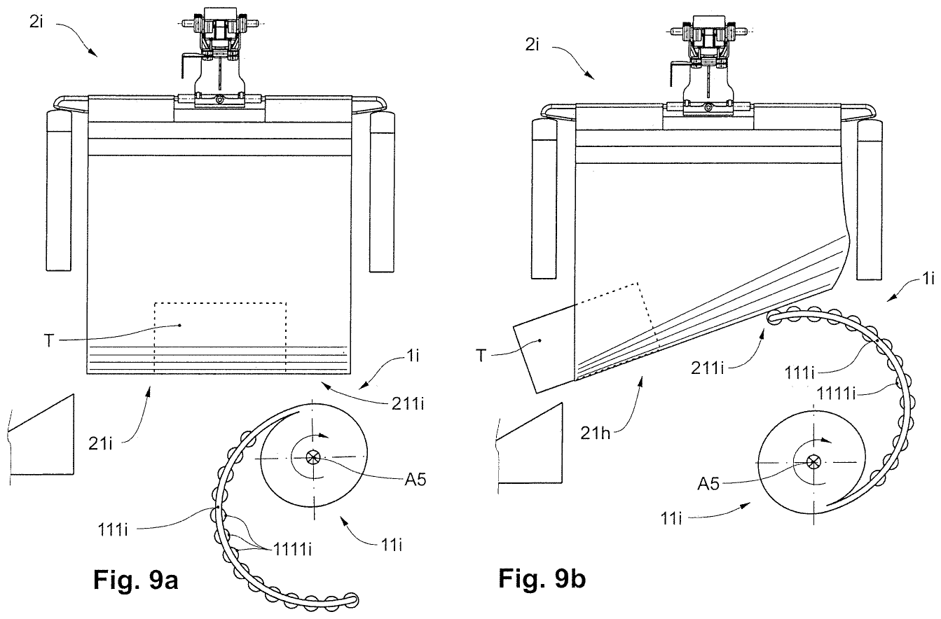

FIGS. 9a-b show frontal views of an embodiment of a bag unloading device 1i having a raising device comprising a roller 11i with a cam designed as a curved limb 111i in two different rotational configurations. Similarly to the embodiment shown in FIG. 7, the radial spacing of the curved limb 111i from the axis of rotation A5 of the roller 11i varies along the direction of rotation. In FIG. 9a, it can for example be seen that the radial spacing of the curved limb 111i from the axis of rotation A5 increases counter to the direction of rotation. Rotation of the roller 11i causes the roller 11i to linearly raise a part 211i of the support surface 21i of the transport bag 2i, such that an item for transport T can be removed laterally from the transport bag 2i. The curved limb 111i has bearing rollers 1111i which make it easier for the limb 111i to roll on the support surface 21i.

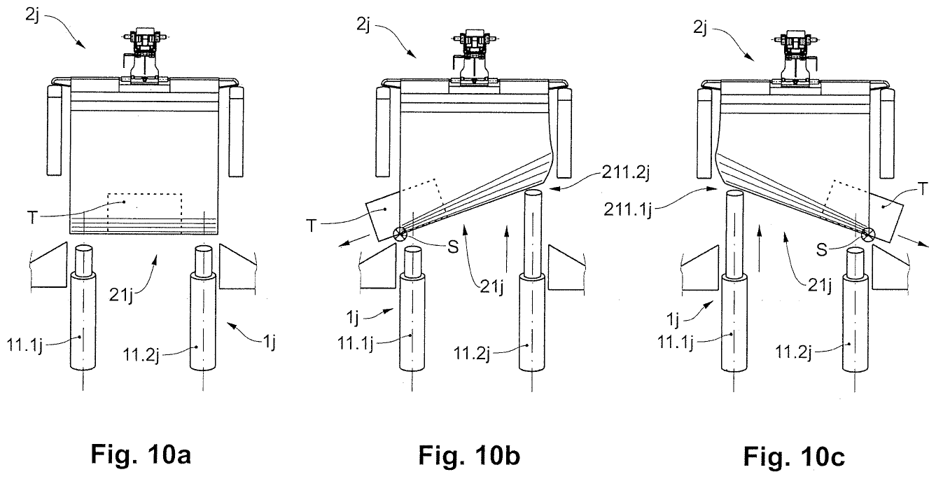

FIGS. 10a-c show frontal views of an embodiment of a bag unloading device 1j having a raising device comprising two oppositely arranged plungers 11.1j and 11.2j. In FIG. 10a, the two plungers 11.1j and 11.2j have not been deployed, such that the support surface 21j of the transport bag 2j with the item for transport T lies horizontally. In FIG. 10b, the right-hand plunger 11.2j has been deployed, such that the right-hand lateral part 211.2j of the support surface 21j is raised and the item for transport T slides out of the transport bag 2j in a left-hand unloading direction. By contrast, in FIG. 10c, only the left-hand plunger 11.1j has been deployed, such that the left-hand lateral part 211.1j of the support surface 21j is raised and the item for transport T slides out of the transport bag 2j in a right-hand unloading direction. The item for transport T can thus be unloaded selectively in both lateral directions or from both lateral openings of the transport bag 2j. The axes S which run through the support surface 21j and about which the support surface 21j is pivoted are shown in FIGS. 10b and 10c.

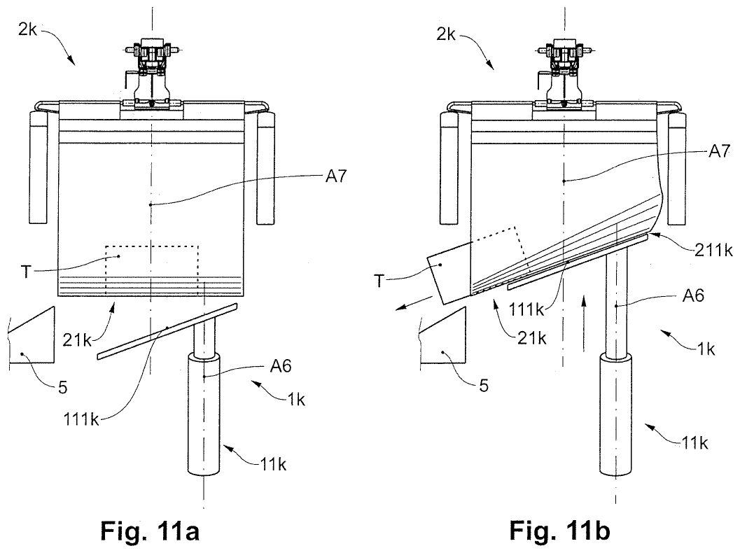

FIGS. 11a-b show frontal views of an embodiment of a bag unloading device 1k with a raising device comprising a plunger 11k with a pushing surface 111k. The pushing surface 111k has a gradient transverse to the conveying direction, wherein the pushing surface 111k is designed to slope downward in an unloading direction. The conveying direction points out of the plane of the drawing.

In FIG. 11a, the plunger 11k has not been deployed, such that the support surface 21k of the transport bag 2k with the item for transport T lies horizontally. The plunger 11k has a longitudinal axis A6, which is arranged offset, transversely with respect to the conveying direction, from a vertical central axis A7 of the transport bag 2k.

In FIG. 11b, the plunger 11k has been deployed, as indicated by the vertical arrow. As a result of the deployment, the pushing surface 111k of the plunger 11k pushes against the support surface 21k from below, such that a part 211k of the support surface 21k is raised such that the support surface 21k forms a slope in an unloading direction. The item for transport T can slide laterally out of the transport bag 2k on the slope of the support surface 21k.

Since the slope of the support surface 21k is stabilized by the pushing surface 11k, no reinforcement of the transport bag 2k in the region of the support surface 21k is required in this embodiment. The gradient of the slope of the support surface 21k corresponds to the gradient of the pushing surface 111k. In certain embodiments, the transport bag 2k may nevertheless have a reinforcement in the region of the support surface 21k.

In FIGS. 11a-b, the pushing surface 111k is designed to slope downward to the left, in order that the item for transport T can be unloaded to the left. It is clear that the pushing surface may correspondingly also be designed to slope downward to the right. In certain embodiments, the pushing surface may be designed to be pivotable, such that the unloading direction can be selectively changed.

By means of the pushing surface 111k of the plunger 11k, it is furthermore possible, as required, for the support surface 21k of the transport bag 2k to be subjected to a linear displacement superposed on the pivoting movement. This may be advantageous for example if the ramp 5 is situated at a level in the case of which the slope of the support surface 21k formed as a result of the raising of the part 211k of the support surface 21k would end below the ramp 5.

What is claimed:

1. A method for unloading an item for transport (T) from a laterally open transport bag (2, 2a-k) comprising:
hanging the laterally open transport bag (2, 2a-k) on a carriage (3);
conveying the item for transport (T) along a running rail (4) in a conveying direction, the item for transport (T) lying on a support surface (21, 21a-k) of the transport bag (2, 2a-k);
unloading the item for transport (T) laterally by virtue of a part (211, 211b-i, 211.1j, 211.2j, 211k) of the support surface (21, 21a-k) of the transport bag (2, 2a-k) being raised in the direction of the hanging point (P) of the transport bag (2, 2a-k) on the carriage (3) by means of a raising device (11, 11b-11i, 11.1j, 11.2j, 11k).

2. The method as claimed in claim 1, wherein a lateral part (211, 211b-i, 211.1j, 211.2j, 211k) of the support surface (21, 21a-k) of the transport bag (2, 2a-k) is raised such that the support surface (21, 21a-k) of the transport bag (2, 2a-k) forms a slope transverse to the conveying direction.

3. The method as claimed in claim 1, wherein a lateral part (211, 211b-i, 211.1j, 211.2j, 211k) of the support surface (21, 21a-k) of the transport bag (2, 2a-k) is raised such that the support surface (21, 21a-k) of the transport bag (2, 2a-k) forms a slope transverse to the conveying direction.

4. The method as claimed in claim 1, wherein a wall surface (241, 242, 241a, 242a, 241d-f), adjoining the support surface (21, 21a-k), of the transport bag (2, 2a-k) is deformed during the raising of the part (211, 211b-i, 211.1j, 211.2j, 211k) of the support surface (21, 21a-k).

5. The method as claimed in claim 1, wherein the support surface (21, 21a-k) of the transport bag (2, 2a-k) is, during the raising of the part (211, 211b-i, 211.1j, 211.2j, 211k) of the support surface (21, 21a-k), pivoted about an axis (S) running through the support surface (21, 21a-k) of the transport bag (2, 2a-k).

6. The method as claimed in claim 1, wherein, during the raising of the part of the support surface, the support surface of the transport bag is pivoted about an axis running through the interior space of the transport bag.

7. The method as claimed in claim 5, wherein the support surface of the transport bag is subjected to a linear displacement superposed on the pivoting movement.

8. The method as claimed in claim 1, wherein the carriage (3) is stopped for the purposes of unloading the item for transport (T) from the transport bag (2, 2b, 2g-k).

9. A bag unloading device (1, 1b-1k) for carrying out the method as claimed in claim 1, comprising a raising device (11, 11b-11i, 11.1j, 11.2j, 11k) which is designed to raise a part (211, 211b-i, 211.1j, 211.2j, 211k) of a support surface (21, 21a-k) of a transport bag (2, 2a-k) in the direction of the hanging point (P) of the transport bag (2, 2a-k) on the carriage (3) such that the support surface (21, 21a-k) forms a slope transverse to the conveying direction.

10. The bag unloading device (1, 1b-1k) as claimed in claim 9, wherein the raising device (11, 11b-11i, 11.1j, 11.2j, 11k) is designed to raise the part (211, 211b-i, 211.1j, 211.2j, 211k) of the support surface (21, 21a-k) of the transport bag (2, 2a-k) such that a wall surface (241, 242, 241a, 242a, 241d-f), adjoining the support surface (21, 21a-k), of the transport bag (2, 2a-k) is deformed.

11. The bag unloading device (1, 1j-k) as claimed in claim 9, wherein the raising device (11, 11.1j, 11.2j, 11k) comprises a height-adjustable plunger (11, 11.1j, 11.2j, 11k) which is configured to displace the part (211, 211.1j, 211.2j, 211k) of the support surface (21, 21j, 21k) of the transport bag (2, 2j, 2k) from below the support surface (21, 21j, 21k) in the direction of the hanging point (P) of the transport bag (2, 2j, 2k) on the carriage (3).

12. The bag unloading device (1k) as claimed in claim 11, wherein the plunger (11k) includes a pushing surface (111k) which has a gradient transverse to the conveying direction, the pushing surface (111k) being designed to slope downward in an unloading direction.

13. The bag unloading device (1c) as claimed in claim 9, wherein the raising device has a positionally fixedly arranged motion guide (11c) which is designed to raise the part (211c) of the support surface (21c) of the transport bag (2c) from below the support surface (21c).

14. The bag unloading device (1b, 1g-i) as claimed in claim 9, wherein the raising device comprises a roller (11b, 11g-i) which is designed to raise a part (211b, 211g-i) of the support surface (21b, 21g-i) by rotation, such that the support surface (21b, 21g-i) forms a slope transverse to the conveying direction.

15. The bag unloading device (1b, 1h) as claimed in claim 14, wherein the roller is designed as a brush roller (11b, 11h), the brush roller (11b, 11h) having a brush trim (111b, 111h) which is configured to raise a part of the support surface (21b, 21h) of the transport bag (2b, 2h) in the direction of the hanging point (P) of the transport bag (2b, 2h) on the carriage (3).

16. The bag unloading device (1g, 1i) as claimed in claim 14, wherein the roller (11g, 11i) has a projection (111g, 111i) which is configured to raise a part of the support surface (21g, 21i) of the transport bag (2g, 2i), in the case of rotation of the roller (11g, 11i).

17. The bag unloading device as claimed in claim 9, wherein the raising device comprises a first engagement means which is designed to engage into a second engagement means of the transport bag and raise the part of the support surface of the transport bag in the direction of the hanging point of the transport bag on the carriage.

18. The bag unloading device as claimed in claim 17, wherein the first and/or the second engagement means comprises at least one out of hook, loop, edge, motion guide, roller, pin.

19. A conveying device (10) comprising a bag unloading device (1, 1b-1k) as claimed in claim 9, a running rail (4) and a multiplicity of laterally open transport bags (2, 2a-k), which can be conveyed in a conveying direction, each hanging on a carriage (3) movable along the running rail (4).

20. The conveying device (10) as claimed in claim 19, wherein the transport bags (2, 2a-j) each comprise a flexible material web (24), each flexible material web (24) hanging on a hanging point (P) on the carriage (3) so as to form a transport strap, the transport bag (2a-j) having a reinforcement (25a, 251a) in the region of the support surface (21a-j) which reinforcement is configured to interact with the raising device (11b-11i, 11.1j, 11.2j) for the raising of a part (211b-i, 211.1j, 211.2j) of the support surface (21a-j) of the transport bag (2a-j).

21. The conveying device (10) as claimed in claim 19, wherein the transport bags (2d-f) have transport bag a reinforcement structure (2411d-f, 24113e, 24114e, 24114f) in the region of at least one wall surface (241d-f) adjoining the support surface (21d-f), of the transport bag (2d-f), which reinforcement structure is configured to provide predetermined fold points (24111d, 24112d, 24115e, 24115f) at which the transport bag (2d-f) is deformable during the raising of the part of the support surface (21d-f) of the transport bag (2d-f).
